(19) United States
(12) Patent Application Publication
(10) Pub. No.: US 2012/0286733 A1
(43) Pub. Date: Nov. 15, 2012

(54) BATTERY SYSTEM AND BATTERY EQUALIZER

(75) Inventors: CHENG-EN CHANG, TAIPEI (TW); MING-WANG CHENG, TAIPEI (TW)

(73) Assignee: LITE-ON CLEAN ENERGY TECHNOLOGY CORP., TAIPEI (TW)

(21) Appl. No.: 13/342,429

(22) Filed: Jan. 3, 2012

(30) Foreign Application Priority Data
May 12, 2011 (TW) 100116657

(51) Int. Cl. H02J 7/00

(52) U.S. Cl. 320/118

(57) ABSTRACT

A battery equalizer for equalizing electrical energy of a first battery unit and a second battery unit includes a first diode, a first switch, a second diode, a second switch, a capacitor and an inductor. The components are electrically connected to be able to form different circuit loops to equalize the electrical energy of the two battery units.

### CROSS-REFERENCE TO RELATED APPLICATION

This application claims priority to Taiwanese Application No. 100116657, filed on May 12, 2011.

### BACKGROUND OF THE INVENTION

1. Field of the Invention

The invention relates to a battery equalizer, and more particularly to a battery equalizer for equalizing electrical energy of series-connected batteries.

2. Description of the Related Art

Battery packs are usually used as an energy storage device in various systems. In order to meet the requirements of specification among different systems, the battery packs are usually disposed in the form of series-connections of a plurality of batteries to fulfill the needs for different systems. Errors of each battery in characteristics will be caused because of different conditions of usage, environments of usage and manufacturing process, and thus the capacities of individual batteries are not uniform. Moreover, charging and over discharging of these batteries can also cause damage to the batteries. Therefore, to effectively and quickly achieve uniform charging and discharging of the battery packs, increase the capacities of the battery packs, and prolong the life span of the battery packs are problems to be solved for series-connected battery packs.

FIG. 1 shows a conventional transformer type equalizer circuit 900. The advantage of the configuration is that each battery 910 requires only one active switch (Q1-Qn), and is easier in control. However, when the series-connected battery pack includes too many batteries 910, the design of the magnetic element inside the transformer becomes more complicated, it is disadvantageous to apply the design to system modules, and it is also difficult to find a suitable iron core.

FIG. 2 shows a battery equalizer circuit 800 of a conventional Cuk transformer. The structure is simple and the electrical energy transfer is fast. However, as the equalizer circuit 800 requires excessive storage elements, i.e., two inductors of Lⱼ and Lⱼ₊₁ and a capacitor Cⱼ, the electrical energy will undergo three energy transformations which results in electrical energy loss in series-connected battery packs having a large number of batteries during the energy transfer. As a consequence, it is unable to effectively demonstrate the advantages of a non-dissipative type equalizer circuit.

### SUMMARY OF THE INVENTION

The object of the present invention is to provide a highly effective battery equalizer applicable to series-connected battery packs having a large number of batteries.

According to the present invention, a battery equalizer is for equalizing electrical energy of a first battery unit and a second battery unit. The battery equalizer comprises a first diode, a first switch, a second diode, a second switch, a capacitor and an inductor.

The first diode has a cathode to be electrically coupled to a positive terminal of the first battery unit, and the first switch is electrically coupled across the first diode. The second diode has an anode to be electrically coupled to a negative terminal of the second battery unit, and the second switch is electrically coupled across the second diode. The capacitor is electrically coupled between the cathode of the first diode and the anode of the second diode. The inductor has one terminal electrically coupled to an anode of the first diode and to a cathode of the second diode, while another terminal is to be electrically coupled to a negative terminal of the first battery unit and to a positive terminal of the second battery unit.

When the first switch is in a conducting state and the second switch is in a non-conducting state, the first battery unit is able to release energy to the inductor, and the capacitor is able to release energy to the second battery unit. When the first switch switches from the conducting state to the non-conducting state such that the second diode is conducting, the first battery unit is able to release energy to the capacitor, and the inductor is able to release energy to the second battery unit; when the first switch is in the non-conducting state and the second switch is in a conducting state, the second battery unit is able to release energy to the inductor, and the capacitor is able to release energy to the first battery unit via the inductor. When the second switch switches from the conducting state to the non-conducting state such that the first diode is conducting, the second battery unit is able to release energy to the capacitor, and the inductor is able to release pre-stored energy to the first battery unit. Thus during the equalizing process, the first battery unit, having a higher level of electrical energy, is constantly releasing electrical energy, and the second battery unit, having a lower level of electrical energy, is constantly storing electrical energy, thereby greatly increasing the equalizing efficiency of the battery system. Moreover, comparing with the conventional equalizers, the present invention only requires an inductor to perform the equalizing operation, hence, it reduces the number of energy conversions, thereby reducing the energy loss during the energy conversion processes and increasing the transmission efficiency.

On a special note, the voltage across the capacitor corresponds to a total voltage of the first battery unit and the second battery unit, the current flowing through the inductor corresponds to a sum of current flowing through the first battery unit and current flowing through the second battery unit.

Additionally, the battery equalizer disclosed in the invention can be used in a battery system. The battery system includes the battery equalizer described as well as a first battery unit, a second battery unit, and a controller used to monitor the stored electrical energy in the first and second battery units to thereby control the on/off of the first and second switches.

When electrical energy of the first battery unit is higher than electrical energy of the second battery unit, the controller controls the first switch to operate in the conducting state and the second switch to operate in the non-conducting state. When the electrical energy of the first battery unit is lower than the electrical energy of the second battery unit, the controller controls the first switch to operate in the non-conducting state and the second switch to operate in the conducting state.

Given the above, the battery equalizer can transfer electrical energy in a battery unit having higher electrical energy to another battery unit having lower electrical energy by the control of the controller on the basis of the electrical energy difference between two battery units, and achieve equal charging and discharging effects in the battery system. Comparing with the conventional equalizers, the present invention only requires an inductor to perform the equalizing operation, hence, it reduces the number of energy conversions, thereby reducing the energy loss during the energy conversion processes and increasing the transmission efficiency.

### BRIEF DESCRIPTION OF THE DRAWINGS

FIG. 1 illustrates a conventional transformer type equalizer circuit;

FIG. 2 illustrates a battery equalizer circuit of a conventional Cuk transformer;

FIG. 3 illustrates the preferred embodiment of the battery system of the present invention;

FIG. 4 shows the charging or discharging circuit path of each component when the electrical energy of the first battery unit is greater than that of the second battery unit, where the first switch is conducting and the second switch is not conducting;

FIG. 5 shows the charging or discharging circuit path of each component when the electrical energy of the first battery unit is greater than that of the second battery unit, where the first switch is switched to a non-conducting state;

FIG. 6 shows the charging or discharging circuit path of each component when the electrical energy of the first battery unit is greater than that of the second battery unit, where the battery equalizer is operated in a non-continuous mode;

FIG. 7 is a timing diagram for circuit operation showing when the electrical energy of the first battery unit is greater than that of the second battery unit;

FIG. 8 is a simulation diagram illustrating the voltage and the current inside the capacitor;

FIG. 9 is a time versus voltage plot of the equalizing process between the first battery unit and the second battery unit;

FIG. 10 shows the charging and discharging circuit path of each component when the electrical energy of the first battery unit is less than that of the second battery unit, where the first switch is not conducting and the second switch is conducting;

FIG. 11 shows the charging and discharging circuit path when the electrical energy of the first battery unit is less than that of the second battery unit, where the second switch is switched to anon-conducting state;

FIG. 12 shows the charging and discharging circuit path when the electrical energy of the first battery unit is less than that of the second battery unit, where the battery equalizer operates in a non-continuous mode; and

FIG. 13 is a circuit diagram showing multiple battery units and battery equalizers in a battery system.

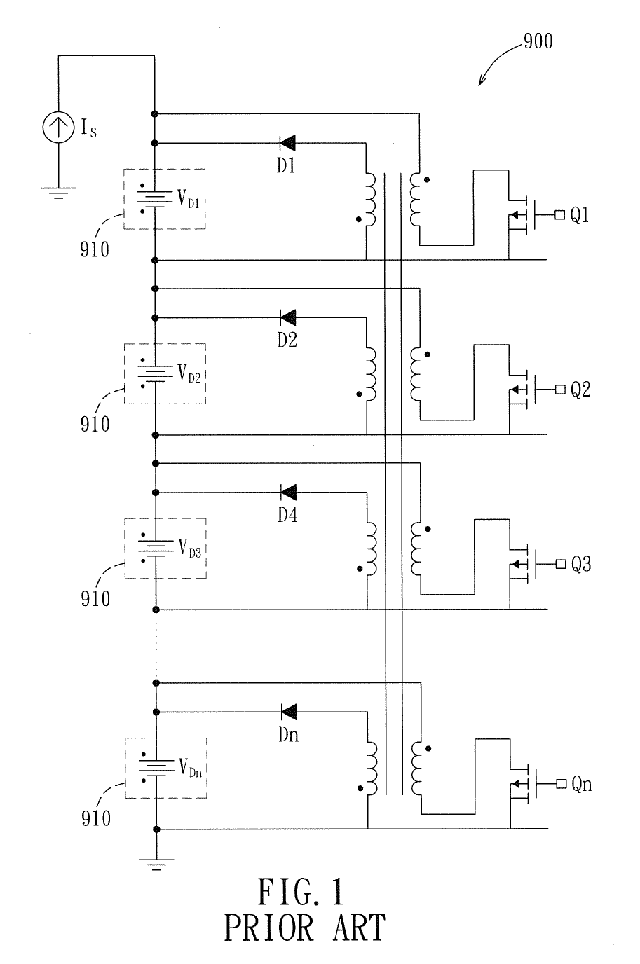

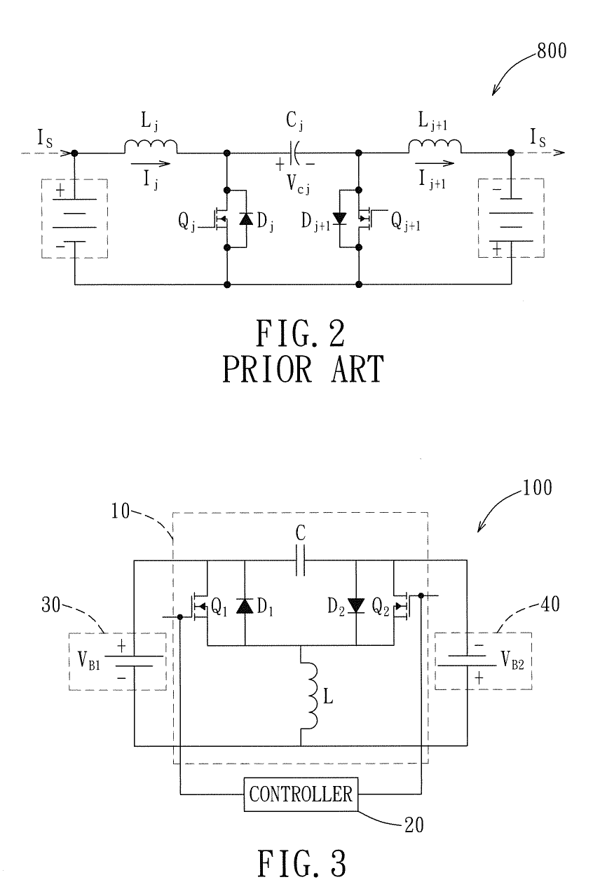

### DETAILED DESCRIPTION OF THE PREFERRED EMBODIMENTS

With regards to the aforementioned and other technical contents, features and effects of the present invention, they will be clearly illustrated by the following detailed description of the preferred embodiments with reference to the accompanying drawings.

Referring to FIG. 3, a battery equalizer 10 is used in a battery system 100. Apart from the battery equalizer 10, the battery system 100 additionally includes a controller 20, and a first battery unit 30 and a second battery unit 40 electrically coupled to the battery equalizer 10. The controller 20 controls the battery equalizer 10 to transfer energy from one of the battery units 30, 40, whichever has higher electrical energy, to the other having lower electrical energy so as to achieve effectiveness of uniformly charging and discharging of the overall battery system. The battery equalizer 10 is applicable to a large number of series-connected battery packs, and can prevent battery units 30, 40 from damage caused by over-charging or over-discharging, thereby promoting usable capacity and service life of the battery system 100. In the present embodiment, the way to determine electrical energy of batteries may be performed through comparing the voltages of the batteries, the state of charge inside the batteries, or the state of discharge. For example, in one embodiment, the voltages of the batteries are compared. The battery with a higher voltage is determined to have higher electrical energy while the battery with a lower voltage is determined to have lower electrical energy. In the case of comparing the state of charge, the battery with a higher state of charge is determined to have higher electrical while the battery with a lower state of charge is determined to have lower electrical energy. In the case of comparing the state of discharge, the battery having discharged greater is determined to have lower electrical energy while the battery having discharged lesser is determined to have higher electrical energy. To simply illustrate the effect of the present invention, the following embodiments and the accompanying figures show the comparison of the degree of voltage in batteries as a reference for determining the degree of electrical energy.

In the present embodiment, the battery equalizer 10 includes a first diode D₁, a second diode D₂, a first switch Q₁, a second switch Q₂, a capacitor C, and an inductor L.

The cathode of the first diode D₁ is electrically coupled to the positive terminal of the first battery unit 30 while the anode of the first diode D₁ is electrically coupled to a first terminal of the inductor L. The first switch Q₁ is an N-type metal oxide semiconductor field effect transistor (N-type MOSFET) having a drain (D) electrically coupled to the cathode of the first diode D₁, a gate (G) electrically coupled to the controller 20, and a source(S) electrically coupled to the anode of the first diode D₁.

The anode of the second diode D₂ is electrically coupled to the negative terminal of the second battery unit 40 while the cathode of the second diode D₂ is electrically coupled to the first terminal 11 of the inductor L. The second switch Q₂ is also an N-type metal oxide semiconductor field effect transistor (N-type MOSFET) having a drain (D) electrically coupled to the anode of the second diode D₂, a gate (G) electrically coupled to the controller 20, and a source(S) electrically coupled to the cathode of the second diode D₂.

One terminal of the capacitor C is electrically coupled to the cathode of the first diode D₁, the drain (D) of the first switch Q₁, and the positive terminal of the first battery unit 30. The other terminal of the capacitor C is electrically coupled to the anode of the second diode D₂, the drain (D) of the second switch Q₂, and the negative terminal of the second battery unit 40. A second terminal 12 of the inductor L is electrically coupled to the negative terminal of the first battery unit 30 and to the positive terminal of the second battery unit 40 to form a charge-and-discharge loop. The controller 20 monitors the stored electrical energy of the first and second battery units 30, 40 so as to control the on/off of the first and second switches Q₁, Q₂.

As the battery equalizer 10 can equalize electrical energy in the first and second battery units 30, 40 by the control of the controller 20 on the basis of the electrical energy difference between the first and second battery units 30, 40, and achieve equal charging and discharging effects in the battery system, therefore, the following will be describing two conditions of when the first battery unit 30 has a higher electrical energy than the second battery unit 40, and when the first battery unit 30 has a lower electrical energy than the second battery unit 40, respectively.

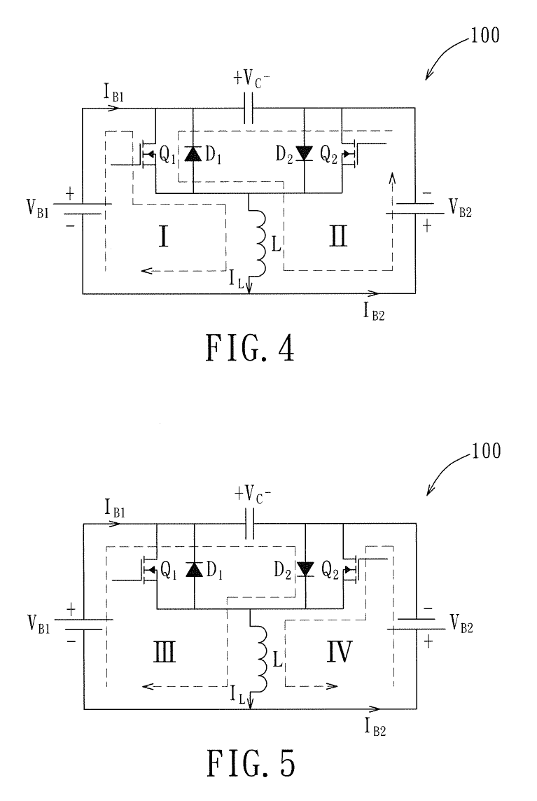

Referring to both FIG. 4 and FIG. 7, when the controller 20 detects the first battery unit 30 having substantially greater electrical energy than the second battery unit 40, the controller 20 controls the battery equalizer 10 to enter a first operation period T₁, the first switch Q₁ to enter a conducting state, and the second switch Q₂ to enter a non-conducting state which allows the first battery unit 30, the first switch Q₁ and the inductor L to form a first loop I, and the capacitor C, the inductor L and the second battery unit 40 to form a second loop II. The first battery unit 30 releases energy to the inductor L, and the capacitor C releases energy to the second battery unit 40 via the inductor L. V_{gs} in FIG. 7 is the conducting voltage of the first switch Q₁.

The capacitor C is cross connected between the first battery unit 30 and the second battery unit 40. Therefore, the voltage V_{c} of the capacitor C will be equivalent to the voltage V_{B1} of the first battery unit 30 plus the voltage V_{B2} of the second battery unit 40, i.e., V_{c}=V_{B1}+V_{B2}. Also, as both the currents of the first and the second loops I, II flow through the inductor L, the current I_{L} of the inductor L will be equivalent to the current I_{B1} coming from the first battery unit 30 plus the current I_{B2} coming from the second battery unit 40, i.e., I_{L}=I_{B1}+I_{B2}.

After maintaining the first operating period T₁ for some time, the controller 20 will control the battery equalizer 10 to enter a second operating period T₂ and control the first switch Q₁ to switch from a conducting state to a non-conducting state (the second switch Q₂ is still in a non-conducting state). Referring to FIG. 5, as the current direction of the inductor L is unchanged, the second diode D₂ will be conducting. It allows the first battery unit 30, the capacitor C, the second diode D₂ and the inductor L to form a third loop III, and the second diode D₂, the inductor L and the second battery unit 40 to form a fourth loop IV. The first battery unit 30 continues to release electrical energy for the capacitor C to store, and the inductor L releases the pre-stored electrical energy to the second battery unit 40.

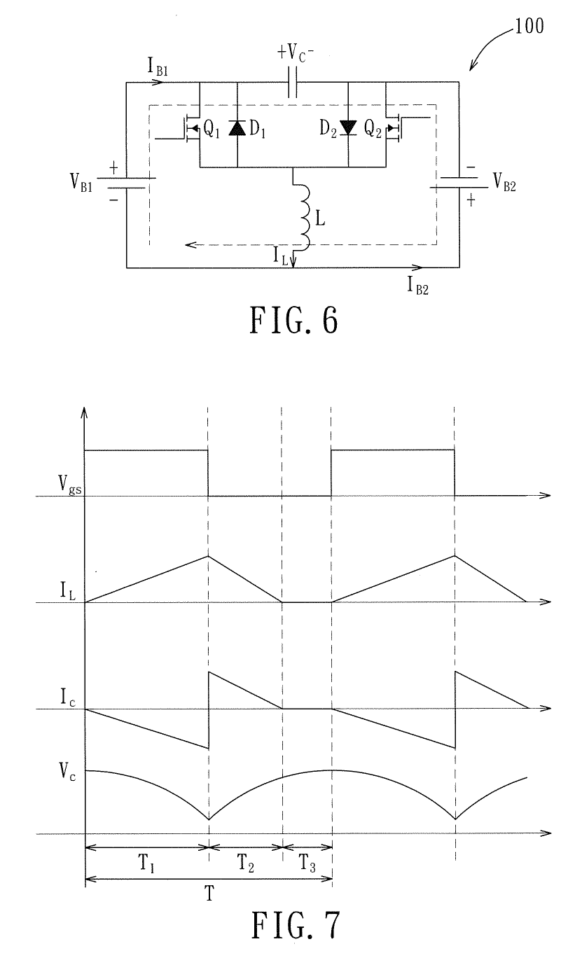

Referring to FIG. 6 and FIG. 7, after the inductor L finishes releasing electrical energy, the second diode D₂ is switched off (i.e., entering a non-conducting state), in the meantime, the battery equalizer 10 enters a third operating period T₃(or non-continuous mode) where the first diode D₁, the second diode D₂, the first switch Q₁ and the second switch Q₂ are all switched off, thereby making sure that the first and second switches Q₁, Q₂ can be switched when there is no current flowing through the inductor L, and thus switching loss can be prevented.

In the present embodiment, the sum of the first operating period T₁, the second operating period T₂ and the third operating period T₃ is the duty cycle T of the battery equalizer 10. When the controller 20 detects that the voltage V_{B1} of the first battery unit 30 is greater than the voltage V_{B2} of the second battery unit 40, the controller 20 controls the battery equalizer 10 to function over the duty cycle T until the first and second battery units 30, 40 have the same voltage. During the whole duty cycle T, the controller 20 only needs to control the first and third operating periods T₁, T₃, because in the second operating period T₂, the battery equalizer 10 enables the second diode D₂ to be conducting by means of having the unchanged current direction of the inductor L, and thus to generate the third loop III and the fourth loop IV. Therefore, the controlling operation of the controller 20 will be further simplified.

In another embodiment, the third operating period T₃ can be designed to be zero which enables the inductor L to receive electrical energy from the first battery unit 30 immediately at the instant the inductor L completely releases electrical energy to the second battery unit 40. The design not only prevents the first and second switches Q₁, Q₂ from switching loss, the equalizing efficiency of the battery equalizer 10 is also substantially increased. In this design, the duty cycle T of the battery equalizer 10 will be limited to the first and second operating periods T1, T2.

During the first operating period T₁, the first battery unit 30 releases electrical energy to the inductor L, and the second battery unit 40 receives electrical energy from the capacitor C. During the second operating period T₂, the second battery unit 40 will receive electrical energy from the inductor L, and in the meanwhile the electrical energy of the capacitor C will be restored by the first battery unit 30. In other words, during the equalizing process, the first battery unit 30, having a higher level of electrical energy, is constantly releasing electrical energy, and the second battery unit 40, having a lower level of electrical energy, is constantly storing electrical energy, thereby greatly increasing the equalizing efficiency of the battery system 100. Moreover, the battery equalizer 10 only requires an inductor L to perform the equalizing operation, hence, it reduces the number of energy conversions, which reduces the energy loss during the energy conversion processes and increases the transmission efficiency.

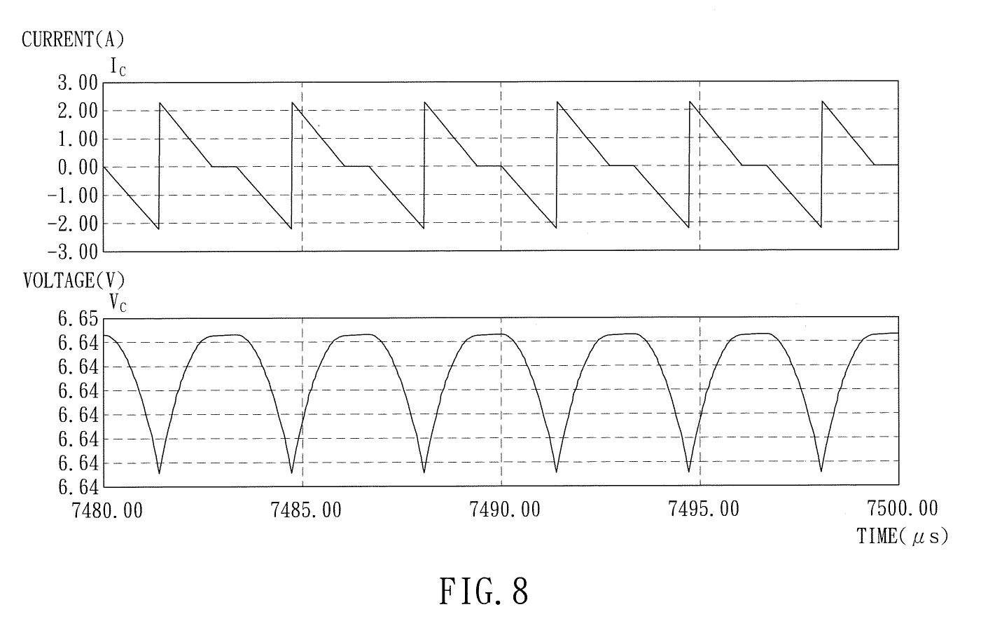

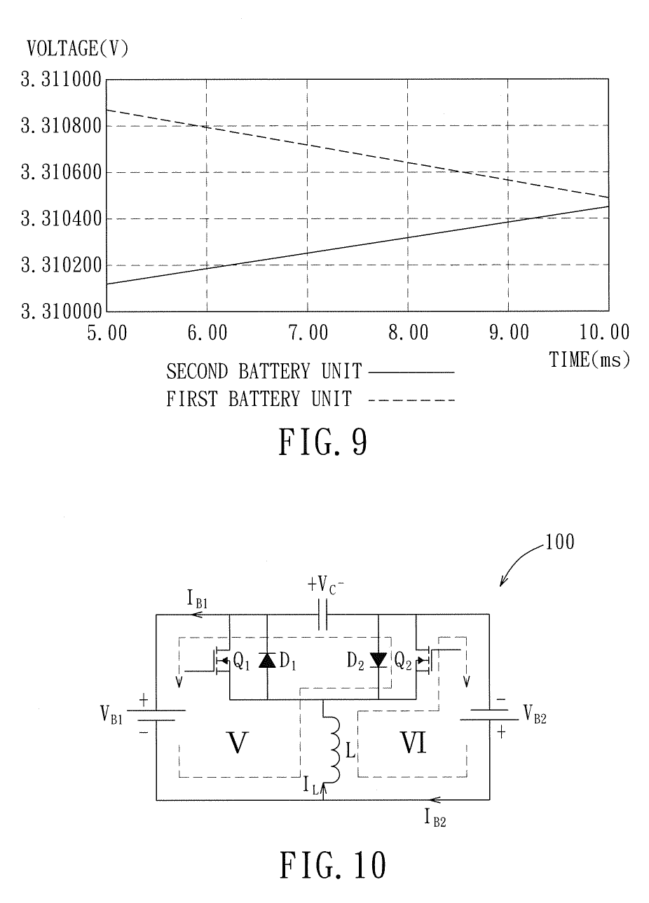

FIG. 8 is a waveform diagram of a current I_{C} and voltage V_{C} during an equalizing operation. FIG. 9 is a simulation of the equalizing behaviour of the battery system 100 when there is a difference between the first battery unit 30 and the second battery system 40, with the simulation processed by a PSIM circuit simulation software. The voltage V_{B1} of the first battery unit 30 is set to be 3.35V, the voltage V_{B2} of the second battery unit 40 is set to be 3.3V, the inductor L is set to have inductance of 1 μH, the capacitor C is set to have capacitance of 270 μF, and 300 KHz is used as the operating frequency. As shown in FIG. 8, the voltage V_{C} across the capacitor C corresponds to a total voltage of the first and second battery units 30, 40 and is maintained the same during the equalizing process. As shown in FIG. 9, the electrical energy of the first and second battery units 30, 40 will be adjusted to be the same after a period of time. In this embodiment, the electrical energy of the first and second battery units 30, 40, whether it is determined by the voltage, the state of charge, or the state of discharge, are adjusted to be the same.

Conversely, when the controller 20 detects the electrical energy of the first battery unit 30 to be lower than that of the second battery unit 40, the controller 20 controls the first switch Q₁ to be in a non-conducting state and the second switch Q₂ to be in a conducting state, as shown in FIG. 10. The first battery unit 30, the capacitor C, the second switch Q₂, and the inductor L form a fifth loop V, and the second switch Q₂, the inductor L, and the second battery unit 40 form a sixth loop VI. The second battery unit 40 will release electrical energy, which is stored in the inductor L, and the capacitor C releases electrical energy via the inductor L to charge the first battery unit 30.

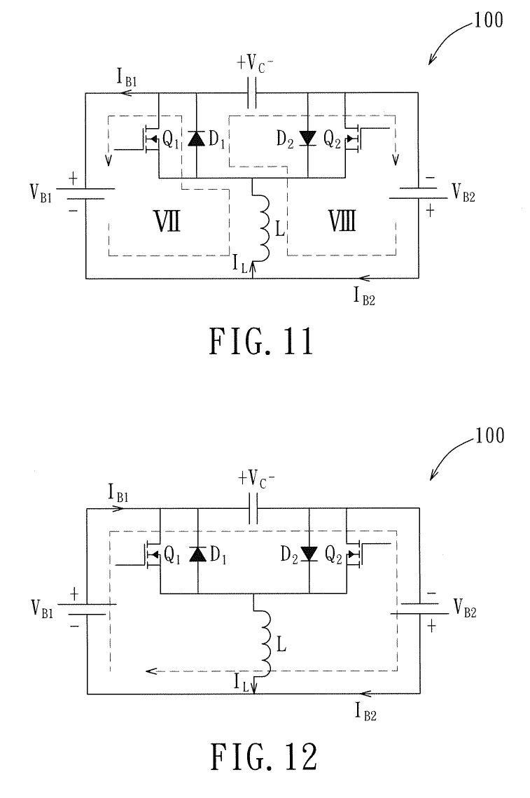

Referring to FIG. 11, after a period of time, the controller 20 will control the second switch Q₂ to switch from the conducting state to the non-conducting state (the first switch Q₁ is still in the non-conducting state), and the first diode D₁ is conducting, thereby enabling the first battery unit 30, the first diode D₁, and the inductor L to form a seventh loop VII, and the capacitor C, the first diode D₁, the inductor L, and the second battery unit 40 to form an eighth loop VIII. The second battery unit 40 continues to release electrical energy and to be stored in the capacitor C, and the inductor L releases the previously stored electrical energy to the first battery unit 30.

Referring to FIG. 12, after the inductor L finishes releasing electrical energy, the first diode D₁ is also entering a non-conducting state, in the meantime, the battery equalizer 10 will enter a non-continuous mode so that the first and second switches Q₁, Q₂ can be switched when there is no current in the inductor L.

In view of FIGS. 10 to 12, the battery equalizer 10 can alter equalizing currents by the controller 20 operated in a non-continuous conducting mode and changing operating frequencies on the basis of the electrical energy difference between the battery units 30, 40. The battery equalizer can efficiently achieve the goal of equalizing the battery units without making any wasteful electrical energy from the battery units.

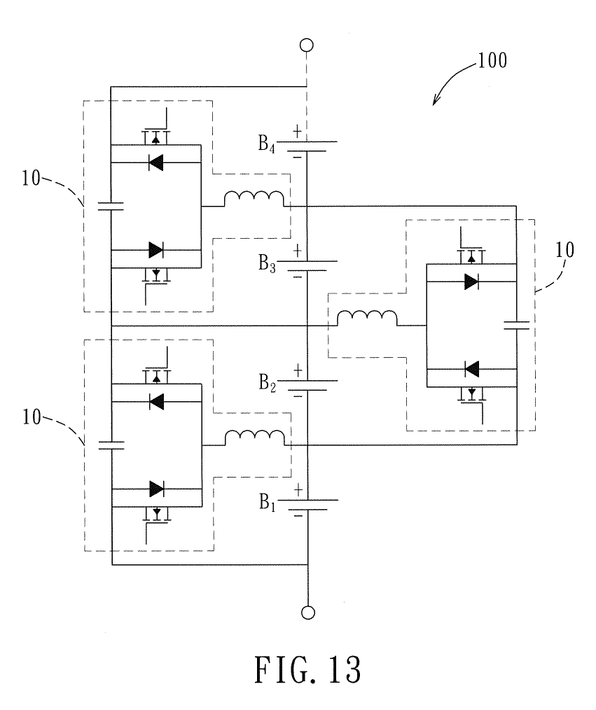

FIG. 13 shows that the battery system 100 includes a plurality of battery units. The battery equalizer 10 is electrically coupled between any two adjacent battery units in order to equalize the electrical energy in all battery units, which achieves an overall charging/discharging balance for the entire battery pack. On a special note, multiple battery equalizers 10 can be configured to be controlled by one single controller 20 (not shown in FIG. 13), or each battery equalizer 10 can be configured to be controlled by one particular controller 20. The invention is not restricted by either configurations.

Given the above, the battery equalizer 10 can transfer electrical energy in a battery unit having higher electrical energy to another battery unit having lower electrical energy by the control of the controller 20 on the basis of the electrical energy difference between two battery units, and achieve equal charging and discharging effects in the battery system 100. In the equalizing process, the battery units with higher electrical energy will continue to be in an energy releasing state while the battery units with lower electrical energy will remain to be in an energy storing state, which increases the equalizing efficiency substantially in the battery system 100. Furthermore, compared with conventional equalizers, the battery equalizer 10 only needs one inductor L, and decreases the number of energy conversions, and thus further leads to the decrease of switching loss during electrical energy transmission. Therefore, it improves the transmission efficiency and achieves the goal of the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A battery equalizer for equalizing electrical energy of a first battery unit and a second battery unit, said battery equalizer comprising:
a first diode having a cathode to be electrically coupled to a positive terminal of the first battery unit;
a first switch electrically coupled across said first diode;
a second diode having an anode to be electrically coupled to a negative terminal of the second battery unit;
a second switch electrically coupled across said second diode;
a capacitor electrically coupled to said cathode of said first diode and said anode of said second diode; and
an inductor having one terminal electrically coupled to an anode of said first diode and to a cathode of said second diode, and the other terminal to be electrically coupled to a negative terminal of the first battery unit and to a positive terminal of the second battery unit.

2. The battery equalizer as claimed in claim 1, wherein
when said first switch is in a conducting state and said second switch is in a non-conducting state, the first battery unit is able to release energy to said inductor, and said capacitor is able to release energy to the second battery unit,
when said first switch switches from the conducting state to the non-conducting state such that said second diode is conducting, the first battery unit is able to release energy to said capacitor, and said inductor is able to release energy to the second battery unit,
when said first switch is in the non-conducting state and said second switch is in a conducting state, the second battery unit is able to release energy to said inductor, and said capacitor is able to release energy to the first battery unit, and
when said second switch switches from the conducting state to the non-conducting state such that said first diode is conducting, the second battery unit is able to release energy to said capacitor, and said inductor is able to release energy to the first battery unit.

3. The battery equalizer as claimed in claim 2, wherein voltage across said capacitor corresponds to a total voltage of the first battery unit and the second battery unit.

4. The battery equalizer as claimed in claim 2, wherein current flowing through said inductor corresponds to a sum of current flowing through the first battery unit and current flowing through the second battery unit.

5. A battery system comprising:
a first battery unit;
a second battery unit;
a controller; and
a battery equalizer including:
a first diode having a cathode electrically coupled to a positive terminal of said first battery unit;
a first switch electrically coupled across said first diode and controlled by said controller;
a second diode having an anode electrically coupled to a negative terminal of said second battery unit;
a second switch electrically coupled across said second diode and controlled by said controller;
a capacitor electrically coupled to said cathode of said first diode and said anode of said second diode; and
an inductor having one terminal electrically coupled to an anode of said first diode and to a cathode of said second diode, and the other terminal electrically coupled to a negative terminal of said first battery unit and to a positive terminal of said second battery unit.

6. The battery system as claimed in claim 5, wherein
when said first switch is in a conducting state and said second switch is in a non-conducting state, said first battery unit is able to release energy to said inductor, and said capacitor is able to release energy to said second battery unit,
when said first switch switches from the conducting state to the non-conducting state such that said second diode is conducting, said first battery unit is able to release energy to said capacitor, and said inductor is able to release energy to said second battery unit,
when said first switch is in the non-conducting state and said second switch is in a conducting state, said second battery unit is able to release energy to said inductor, and said capacitor is able to release energy to said first battery unit, and
when said second switch switches from the conducting state to the non-conducting state such that said first diode is conducting, said second battery unit is able to release energy to said capacitor, and said inductor is able to release energy to said first battery unit.

7. The battery system as claimed in claim 6, wherein
when electrical energy of said first battery unit is higher than electrical energy of said second battery unit, said controller controls said first switch to operate in the conducting state and said second switch to operate in the non-conducting state, and
when the electrical energy of said first battery unit is lower than the electrical energy of said second battery unit, said controller controls said first switch to operate in the non-conducting state and said second switch to operate in the conducting state.

8. The battery system as claimed in claim 7, wherein voltage across said capacitor corresponds to a total voltage of said first battery unit and said second battery unit.

9. The battery system as claimed in claim 6, wherein current flowing through said inductor corresponds to a sum of current flowing through said first battery unit and current flowing through said second battery unit.
